(19) United States
(12) Patent Application Publication
(10) Pub. No.: US 2006/0078280 A1
(43) Pub. Date: Apr. 13, 2006

(54) Digital image signal processing apparatus and controlling method used in the same

(75) Inventor: Naozumi Koshino, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/231,786

(22) Filed: Sep. 22, 2005

(30) Foreign Application Priority Data
Sep. 27, 2004 (JP) 2004-280695

(51) Int. Cl. H04N 5/76

(52) U.S. Cl. 386/46; 386/125

(57) ABSTRACT

A digital image signal processing apparatus includes a storage device to store a plurality of identification information for identifying the respective the plurality of recording media, an acquiring device to acquire a registration file describing identification information of the respective recording media in initial registration, when there occurs a request to execute at least one of writing and reading of a digital image signal, a detector which detects change in the identification information of the designated recording medium by comparing an identification information corresponding to the designated recording medium in the registration file with the corresponding identification information stored in the storage device, and a controller which displays on the display a message indicating failure in access to the recording medium, when the detector detects change in the identification information.

### CROSS-REFERENCE TO RELATED APPLICATIONS

This application is based upon and claims the benefit of priority from prior Japanese Patent Application No. 2004-280695, filed Sep. 27, 2004, the entire contents of which are incorporated herein by reference.

### BACKGROUND OF THE INVENTION

1. Field of the Invention

This invention relates to a digital image signal processing apparatus, which selectively performs reading and writing of any digital image signal to a designated recording medium among a plurality of recording medium, such as an HDD (Hard Disk Drive) and a memory card, and displays the digital image signal which is being read or written on a television set, and a controlling method used in the digital image signal processing apparatus.

2. Description of the Related Art

As is generally known, digitalization of television broadcasting has recently been promoted. For example, in Japan, terrestrial digital broadcasting has been started, as well as satellite digital broadcasting such as BS (Broadcasting Satellite) digital broadcasting and CS (Communication Satellite) 110° digital broadcasting.

Digital broadcasting receivers which receive such digital television broadcasting can record received programs in digital form, and reproduce the recorded programs, by connecting digital recording apparatuses of a large capacity such as HDD (Hard Disk Drive) thereto.

Further, currently, a plurality of digital recording apparatuses are connected to one digital broadcasting receiver to form a network, and thereby the digital broadcasting receiver can designate any one of the digital recording apparatuses to have it record broadcasting contents, and designate any one of the digital recording apparatuses to have it reproduce a recorded broadcasting contents. Further, there have been proposed a digital broadcasting receiver having an Image displaying function which a plurality of recorded picture on the memory card.

In most cases, in the digital broadcasting receiving apparatuses, digital recording apparatuses on the network or software which records broadcasting content is managed by NetBios name or IP (Internet Protocol) address (for example, Jpn. Pat. Appln. KOKAI Pub. No. 2003-299008).

In the meantime, in the digital broadcasting receivers, it is probable that the NetBios name or the IP address is automatically changed not only by the user but also due to change of the network environment. Therefore, after a digital recording apparatus has stored a broadcasting content, it is possible that the receiver fails to access the digital recording apparatus storing the content, and that the receiver misidentifies another digital recording apparatus as the digital recording apparatus storing the content. The user cannot identify the cause of such problems.

### BRIEF SUMMARY OF THE INVENTION

The object of the present invention is to provide a digital image signal processing apparatus, which can inform the user of change in identification information when a digital image signal is recorded in or reproduced from a recording medium whose identification information has been changed, even if identification information for identifying the digital recording apparatus is changed, and a controlling method used in the digital image signal processing apparatus.

According to an aspect of the present invention, there is provided a digital image signal processing apparatus selectively performing reading and writing of any digital image signal to a designated recording medium among a plurality of recording media, to each of which a digital image signal is writable, and displaying the digital image signal which is being at least one of read and written on a display, the apparatus comprising: a storage device to store a plurality of identification information for identifying the respective recording media; an acquiring device to acquire a registration file describing identification information of the respective recording media in initial registration, when there occurs a request to execute at least one of writing and reading of a digital image signal, the request designating one of the recording media; a detector which detects change in the identification information of the designated recording medium by comparing an identification information corresponding to the designated recording medium in the registration file with the corresponding identification information stored in the storage device; and a controller which displays on the display a message indicating failure in access to the recording medium, when the detector detects change in the identification information.

According to another aspect of the present invention, there is provided a controlling method used in a digital image signal processing apparatus selectively performing reading and writing of any digital image signal to a designated recording medium among a plurality of recording media, to each of which a digital image signal is writable, and displaying the digital image signal which is being at least one of read and written on a display, the method comprising: storing a plurality of identification information for identifying the respective information media on a nonvolatile memory; acquiring a registration file describing identification information items of the respective recording media in initial registration, when there occurs a request to execute at least one of writing and reading of a digital image signal, the request designating one of the recording media; comparing an identification information corresponding to the designated recording medium in the registration file with the corresponding identification information stored in the nonvolatile memory, and thereby detecting change in the identification information of the designated recording medium; and displaying on the display a message indicating failure in access to the recording medium, when the change in the identification information of the designated recording medium is detected.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically illustrating a digital television broadcasting receiver according to a first embodiment of the present invention, and an example of a network system including the digital television broadcasting receiver as a main part.

FIG. 2 is a block diagram illustrating a main signal processing system of the digital television broadcasting receiver of the first embodiment.

FIG. 3 is a diagram illustrating operation in which the digital television broadcasting receiver accesses a designated HDD.

FIG. 4 is a flowchart illustrating a registration procedure of registering a storage ID by the digital television broadcasting receiver in the first embodiment.

FIG. 5 is a flowchart illustrating an access procedure of accessing a designated HDD by the digital television broadcasting receiver in the first embodiment.

FIG. 6 is a block diagram illustrating a main signal processing system of a digital television broadcasting receiver according to a second embodiment of the present invention.

FIG. 7 is a diagram illustrating an example of storage contents of a guidance memory in the digital television broadcasting receiver of the second embodiment.

FIG. 8 is a flowchart illustrating an access procedure of accessing a designated HDD by the digital television broadcasting receiver in the second embodiment.

### DETAILED DESCRIPTION OF THE INVENTION

Embodiments of the present invention will be described in detail below with reference to drawings.

### FIRST EMBODIMENT

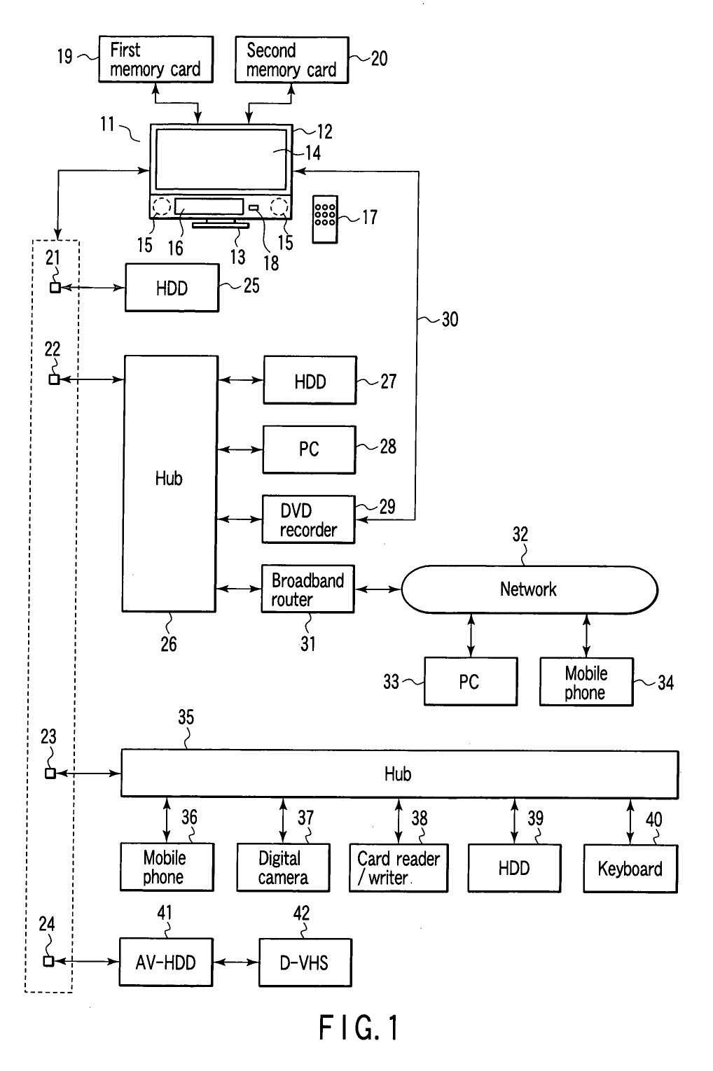

FIG. 1 schematically illustrates an appearance of a digital television broadcasting receiver 11 to be explained as a first embodiment of the present invention, and an example of a network system including the digital television broadcasting receiver 11 as main part.

Specifically, the digital television broadcasting receiver 11 mainly comprises a thin cabinet 12, and a support stand 13 which supports the cabinet 12 in a standing state. Further, the cabinet 12 is provided with a flat-panel image display 14 formed of a liquid crystal display panel and the like, a speaker 15, an operating section 16, and a light-receiving section 18 which receives operation information transmitted from a remote controller 17.

A first memory card 19, such as an SD (Secure Digital) memory card, an MMC (Multimedia Card) and a memory stick, is removably inserted into the digital television broadcasting receiver 11. Information such as programs and photographs are recorded on and reproduced from the first memory card 19.

Further, a second memory card (IC card) 20 recording contract information and the like is removably inserted into the digital television broadcasting receiver 11. Information is recorded on and reproduced from the second memory card 20.

The digital television broadcasting receiver 11 also comprises a first LAN (Local Area Network) terminal 21, a second LAN terminal 22, a USB (Universal Serial Bus) terminal 23 and an i. Link terminal 24.

Among the terminals, the first LAN terminal 21 is used as a port dedicated to a LAN-ready HDD. The first LAN terminal 21 is used to record and reproduce information on and from a LAN-ready HDD 25, which is a NAS (Network Attached Storage) connected to the LAN terminal 21, by Ethernet (registered trademark).

As described above, providing the first LAN terminal 21 as a port dedicated to a LAN-ready HDD enables stable information recording of programs with a high-definition television image quality on the HDD 25.

The second LAN terminal 22 is used as a general LAN-ready port using the Ethernet. For example, the second LAN terminal 22 is connected to apparatuses such as a LAN-ready HDD 27, a PC (Personal Computer) 28, an HDD-included DVD (Digital Versatile Disk) recorder 29 through a hub 26, and is used to perform information transmission with these apparatuses.

With respect to the DVD recorder 29, the digital information of the DVD recorder 29 transmitted through the second LAN terminal 22 is only controlling information. Therefore, it is necessary to provide a dedicated analog transmission line 30, to transmit analog image and sound information between the DVD recorder 29 and the digital television broadcasting receiver 11.

Further, the second LAN terminal 22 is connected to a network 32 such as the Internet through a broadband router 31 connected to the hub 26, and is used to perform information transmission with a PC 33 and a cellular phone 34 and the like through the network 32.

The USB terminal 23 is used as a general USB-ready port. For example, the USB terminal 23 is connected to USB apparatuses such as a cellular phone 36, a digital camera 37, a card reader/writer 38 for a memory card, an HDD 39, and a keyboard 40, through a hub 35, and is used to perform information transmission with these USB apparatuses.

The i. Link terminal 24 is connected to an AV-HDD 41 and a D (Digital)-VHS (Video Home System) 42 in series, and is used to perform information transmission with these apparatuses.

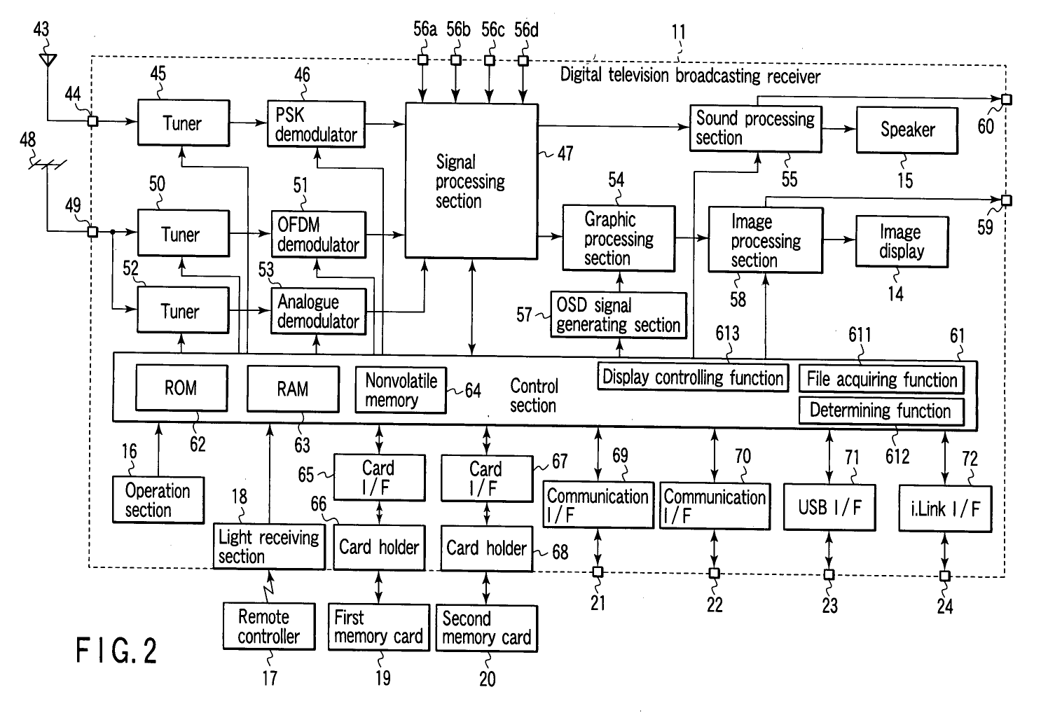

FIG. 2 illustrates a main signal processing system of the digital television broadcasting receiver 11. Specifically, satellite digital television broadcasting signals received by an antenna 43 for receiving BS/CS digital broadcasting are supplied to a satellite digital broadcasting tuner 45 through an input terminal 44, and thereby a broadcasting signal of a desired channel is selected from the signals.

The broadcasting signal selected by the tuner 45 is supplied to a PSK (Phase Shift Keying) demodulator 46, demodulated to a digital image signal and a digital sound signal, and thereafter outputted to a signal processing section 47.

Terrestrial digital television broadcasting signals received by an antenna 48 for receiving terrestrial broadcasting are supplied to a terrestrial digital broadcasting tuner 50 through an input terminal 49, and thereby a broadcasting signal of a desired channel is selected from the signals.

The broadcasting signal selected by the tuner 50 is supplied to an OFDM (Orthogonal Frequency Division Multiplexing) demodulator 51, demodulated to a digital image signal and a digital sound signal, and outputted to the signal processing section 47.

Terrestrial analog television broadcasting signals received by the antenna 48 for receiving terrestrial broadcasting are supplied to a terrestrial analogue broadcasting tuner 52 through the input terminal 49, and thereby a broadcasting signal of a desired channel is selected from the signals. The broadcasting signal selected by the tuner 52 is supplied to an analogue demodulator 53, demodulated to an analogue image signal and an analogue sound signal, and outputted to the signal processing section 47.

The signal processing section 47 selectively performs a predetermined digital signal processing to the digital image signals and the digital sound signals provided from the PSK demodulator 46 and the OFDM demodulator 51, and outputs them to a graphic processing section 54 and a sound processing section 55.

A plurality of (4 in the illustrated example) input terminals 56a, 56b, 56c and 56d are connected to the signal processing section 47. Each of the input terminals 56a to 56d enables input of analogue image signals and analogue sound signals from the outside of the digital television broadcasting receiver 11.

The signal processing section 47 selectively digitizes analogue image signals and analogue sound signals supplied from the analogue demodulator 53 and the input terminals 56a to 56d, performs a predetermined digital signal processing to the digitized image signals and sound signals, and outputs them to the graphic processing section 54 and the sound processing section 55.

Among them, the graphic processing section 54 has a function of superposing an OSD (On Screen Display) signal generated by an OSD signal generating section 57 on the digital image signal supplied from the signal processing section 47, and outputting the superposed signal. The graphic processing section 54 can selectively output the output image signal of the signal processing section 47 and the output OSD signal of the OSD signal generating section 57. Further, the graphic processing section 54 can output both the signals in combination such that each of them form a half of the screen.

The digital image signal outputted from the graphic processing section 54 is supplied to an image processing section 58. The image processing section 58 converts the input digital image signal into an analogue image signal in a format which enables display thereof on the image display 14. Then, the image processing section 58 outputs the converted signal to the image display 14 to display it as an image, and guides it to the outside through an output terminal 59.

The sound processing section 55 converts the input digital sound signal into an analogue sound signal in a format which enables reproduction thereof by the speaker 15. Then, the sound processing section 55 outputs the converted signal to the speaker 15 to reproduce it as sound, and guides it to the outside through an output terminal 60.

A control section 61 controls all the operations of the digital television broadcasting receiver 11, including the above receiving operations. The control section 61 includes a CPU (Central Processing Unit) and the like. The control section 61 receives operation information from the operating section 16, or receives operation information transmitted from the remote controller 17 through the light-receiving section 18, and controls the sections of the receiver 11 to reflect the operation indicated by the operation information.

In this example, the control section 61 mainly comprises a ROM (Read Only Memory) 62 storing a control program to be executed by the CPU, a RAM (Random Access Memory) 63 which provides a work area to the CPU, and a nonvolatile memory 64 storing various setting information and control information and the like.

The control section 61 is connected to a card holder 66, into which the first memory card 19 is can be fitted, with a card I/F (Interface) 65 interposed therebetween. Thereby, the control section 61 can perform information transmission with the first memory card 19 fitted into the card holder 66 through the card I/F 65.

Further, the control section 61 is connected to a card holder 68, into which the second memory card 20 can be fitted, with a card I/F 67 interposed therebetween. Thereby, the control section 61 can perform information transmission with the second memory card 20 fitted into the card holder 68 through the card I/F 67.

The control section 61 is also connected to the first LAN terminal 21 through a communication I/F 69. Thereby, the control section 61 can perform information transmission with the LAN-ready HDD 25 connected to the first LAN terminal 21, through the communication I/F 69. In this case, the control section 61 has a DHCP (Dynamic Host Configuration Protocol) server function, and performs control by assigning an IP (Internet Protocol) address to the LAN-ready HDD 25 connected to the first LAN terminal 21.

The control section 61 is also connected to the second LAN terminal 22 through a communication I/F 70. Thereby, the control section 61 can perform information transmission with the apparatuses (see FIG. 1) connected to the second LAN terminal 22 through the communication I/F 70.

The control section 61 is also connected to the USB terminal 23 through a USB I/F 71. Thereby, the control section 61 can perform information transmission with the apparatuses (see FIG. 1) connected to the USB terminal 23 through the USB I/F 71.

The control section 61 is also connected to the i. Link terminal 24 through an i. Link I/F 72. Thereby, the control section 61 can perform information transmission with the apparatuses (see FIG. 1) connected to the i. Link terminal 24 through the i. Link I/F 72.

In the first embodiment, the HDD 25 stores a registration file describing storage IDs (including IP addresses and apparatus names) assigned to the respective HDD 25, HDD 27, PC 28, DVD recorder 29 in initial registration.

Further, the nonvolatile memory 64 stores respective storage IDs of the HDD 25, HDD 27, PC 28 and DVD recorder 29.

Furthermore, the control section 61 is provided with a file acquiring function 611, a determining function 612, and a display controlling function 613, as functions related to the present invention. The file acquiring function 611 acquires a registration file from the HDD 25, if there occurs a request of executing any one of recording or reproduction of a digital image signal, which designates the HDD 27, for example.

The determining function 612 compares the storage ID of the HDD 27 in the registration file with the storage ID of the HDD 27 stored in the nonvolatile memory 64, and thereby determines whether the storage IDs match.

If the storage IDs match, the display controlling function 613 executes recording or reproduction of the digital image signal to the HDD 27. If the storage IDs do not match, the display controlling function 613 displays a message indicating it with the storage IDs on the image display 14 by an OSD.

Next, processing operation in the above structure is explained.

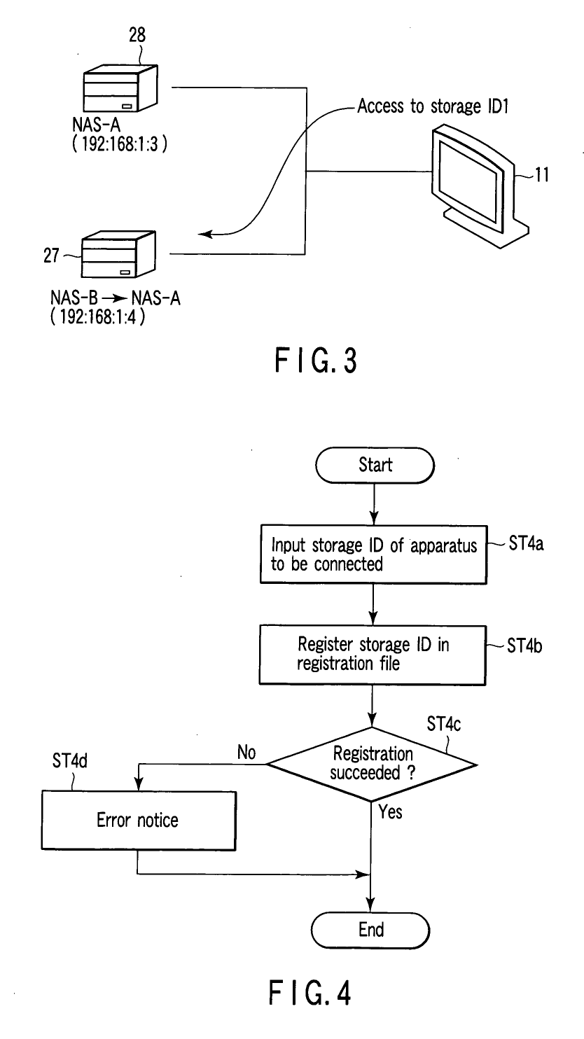

Suppose that the HDD 27 is connected to the digital television broadcasting receiver 11 as shown in FIG. 3, for example. Then, the control section 61 of the digital television broadcasting receiver 11 enters a registration mode, and executes the procedure shown in FIG. 4.

First, the control section 61 displays a storage ID input guidance picture on the image display 14 (step ST4a). When the user inputs a storage ID of the PC 28 in this state, the control section 61 registers the input storage ID in the registration file stored in the HDD 25 (step ST4b), and determines whether the registration succeeded or not (step ST4c).

When the registration ended in failure (No), the control section 61 displays an error message on the image display 14 (step ST4d). If the registration succeeded (Yes), the control section 61 ends the registration.

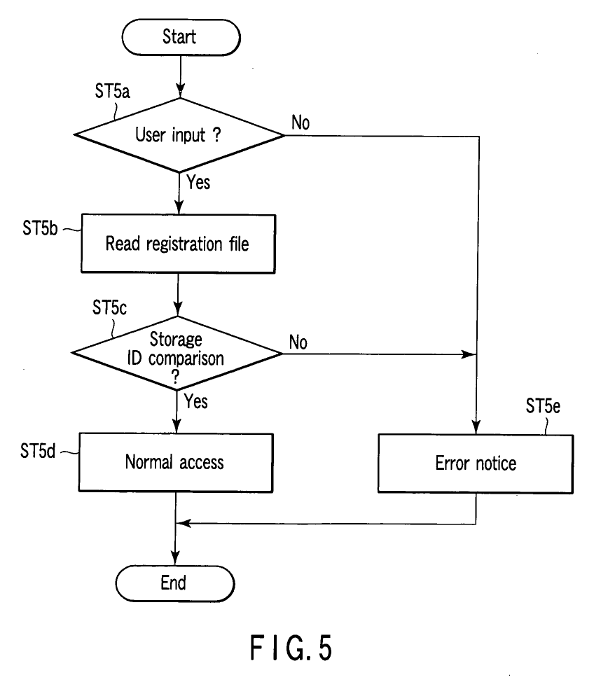

In the meantime, if a digital image signal is to be recorded on, for example, the HDD 27, the control section 61 executes the procedure shown in FIG. 5.

When recording is performed, the user places the receiver 11 in a recording mode, by operating the remote controller 17. Then, the control section 61 displays the input guidance picture on the image display 14, and determines whether the user inputs a designated storage ID (step ST5a).

If the storage ID designating the HDD 27 is input (Yes), the control section 61 reads the registration file from the HDD 27 (step ST5b), compares the designated storage ID in the registration file with the storage ID stored in the nonvolatile memory 64, and thereby determines whether the storage ID has been changed or not (step ST5c).

If the storage IDs match (Yes), the control section 61 executes normal access to the designated HDD 27 (step ST5d). If the storage ID has been changed (No), the control section 61 supplies a message indicating change of the ID and the storage IDs to the image display 14, and display them in an OSD form on the image display 14 (step ST5e). Therefore, this display notifies the user of change in the storage. ID of the HDD 27 designated.

Further, if the user input ends in failure in the step ST5a, the control section 61 supplies a message indicating the input failure and the storage IDs to the image display 14, and display them in an OSD form on the image display 14.

As described above, according to the first embodiment, storage IDs of the HDD 25, HDD 27, PC 28 and DVD recorder 29 to be connected to the digital television broadcasting receiver 11 are registered in file form in the HDD 25 in initial registration, and the storage IDs of the HDD 25, HDD 27, PC 28 and DVD recorder 29 are registered in the nonvolatile memory 64. When there occurs a request, which designates the HDD 27, to execute recording or reproduction of a digital image signal, the control section 61 acquires the registration file from the HDD 25 prior to execution thereof, compares the storage ID in the registration file with the storage ID stored in the nonvolatile memory 64, and determines whether the storage ID has been changed or not. If the storage ID has been changed, the control section 61 displays a message indicating failure in access to the HDD 27 on the image display 14.

Therefore, the structure of the first embodiment prevents access to a wrong apparatus, registration of a wrong storage ID, unauthorized change of apparatuses, and unauthorized change of the storage ID. Further, the structure of the first embodiment also prevents recording and reproduction of an improper digital image signal.

### SECOND EMBODIMENT

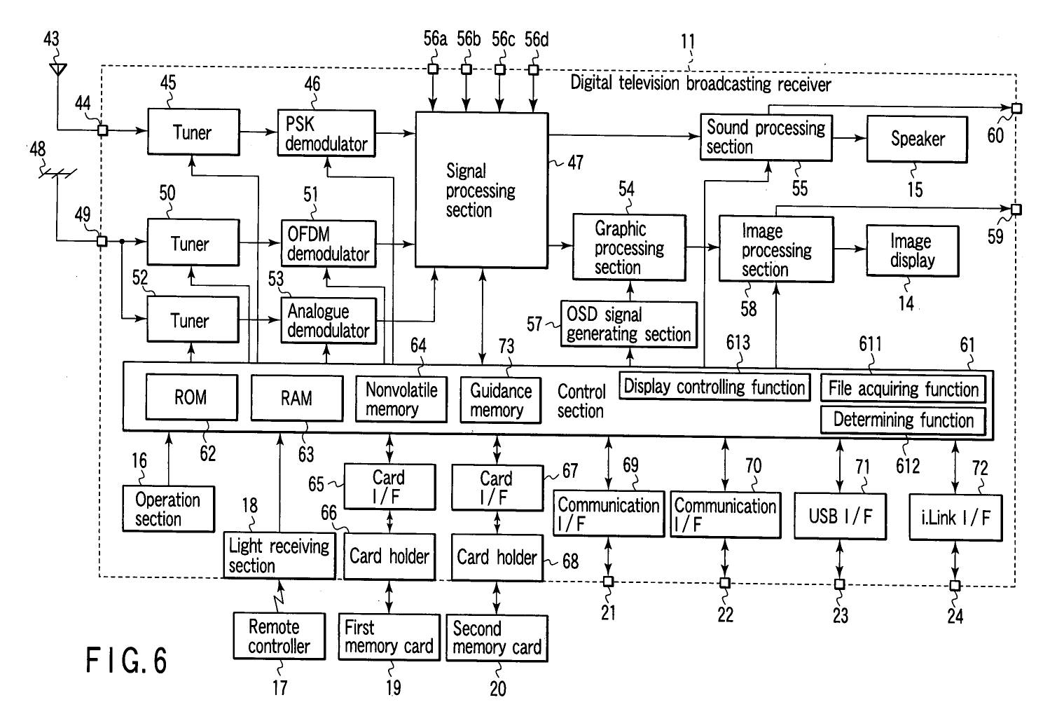

FIG. 6 is a block diagram illustrating functions and configuration of a digital television broadcasting receiver 11 according to a second embodiment of the present invention. In FIG. 6, the same reference numerals are assigned to the same respective members as those in FIG. 2, and their detailed explanations are omitted.

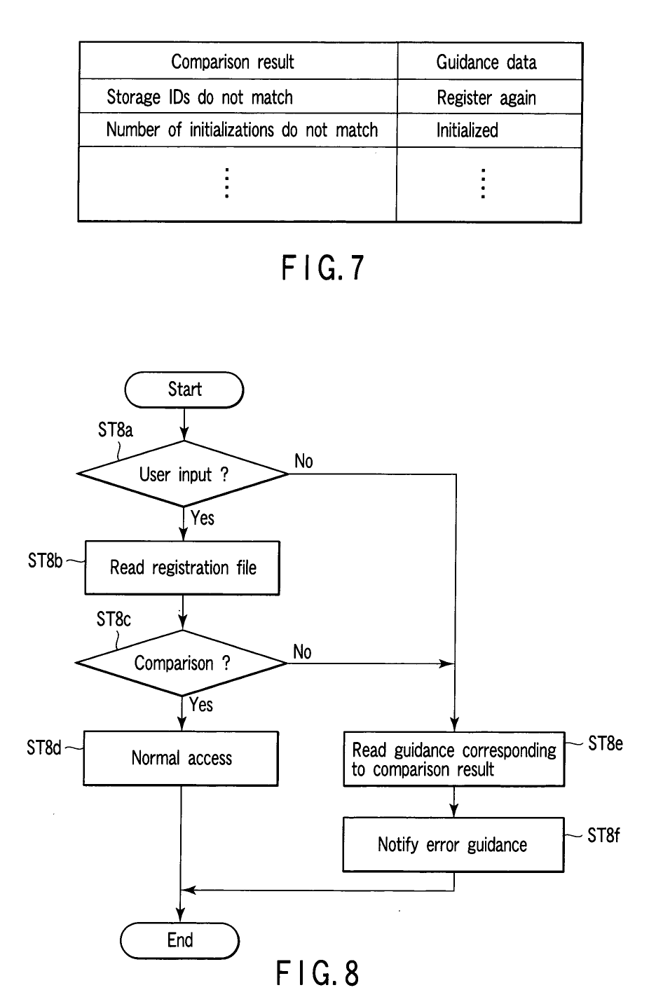

Specifically, a control section 61 is provided with a guidance memory 73. As shown in FIG. 7, the guidance memory 73 stores correlation between comparison results of the registration file with the stored contents of the nonvolatile memory 64 and guidance data to be displayed on the image display 14.

Further, the registration file stored in the HDD 25 describes not only storage IDs but also the number of initializations of the respective apparatuses corresponding to the storage IDs. Further, the nonvolatile memory 64 stores not only the storage IDs but also information of the number of initializations of the respective apparatuses corresponding to the storage IDs.

Next, the processing operation in the above structure is explained.

For example, when a digital image signal is recorded on the HDD 27, the control section 61 executes processing as shown in FIG. 8.

When recording is performed, the user places the receiver 11 in a recording mode by operating the remote controller 17. Then, the control section 61 displays an input guidance picture on the image display 14, and determines whether the user inputs a predetermined storage ID (step ST8a).

If the storage ID designating the HDD 27 is input (Yes), the control section 61 reads the registration file from the HDD 27 (step ST8b), compares the registration file with the data stored in the nonvolatile memory 64, and thereby determines whether the storage ID has been changed and the numbers of initializations match with each other (step ST8c).

If the storage IDs match (Yes), the control section 61 performs normal access to the designated HDD 27 (step ST8d). If the storage ID has been changed (No), the control section 61 reads the corresponding guidance data “Register Again” from the guidance memory 73 (step ST8e), and supplies a message indicating change, the storage IDs and the guidance data to the image display 14 to display them in the OSD form on the image display 14 (step ST8f).

Further, if the numbers of initializations differ, the control section 61 reads the corresponding guidance data “Initialized” from the guidance memory 73, and supplies a message indicating that the numbers of initializations differ and the guidance data to the image display 14 to display them in the OSD form on the image display 14 (step ST8f).

As described above, according to the second embodiment, the control section 61 is provided with the guidance memory 73 which stores guidance data corresponding to the comparison results of the registration file with the registered data of the nonvolatile memory 64, to display on the image display 14 not only a message indicating failure in access to the designated HDD 27, but also the reason or corresponding guidance data. This enables the user to understand the cause of the failure and perform an appropriate reattempt operation and the like.

Further, according to the second embodiment, it is possible to check the number of initializations of the designated HDD 27, and thereby it is possible to check inappropriate initialization, connection of an unauthorized apparatus, and unauthorized initialization of the apparatuses.

### OTHER EMBODIMENTS

The present invention is not limited to the above embodiments. For example, in the above embodiments, explained is an example wherein the registration file is stored in the HDD 25. However, the present invention is not limited to it, but the registration file may be registered in a memory card or the like. This structure enhances the security against unauthorized change of the storage ID.

The present invention is not limited to the above embodiments, but can be variously modified in carrying out it without departing from the gist of the invention. Further, various inventions can be made by combining a plurality of constituent elements disclosed in the above embodiments according to necessity. For example, some of the constituent elements disclosed in an embodiment may be deleted. Further, constituent elements of different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital image signal processing apparatus selectively performing reading and writing of any digital image signal to a designated recording medium among a plurality of recording media, to each of which a digital image signal is writable, and displaying the digital image signal which is being at least one of read and written on a display, the apparatus comprising:
a storage device to store a plurality of identification information for identifying the respective recording media;
an acquiring device to acquire a registration file describing identification information of the respective recording media in initial registration, when there occurs a request to execute at least one of writing and reading of a digital image signal, the request designating one of the recording media;
a detector which detects change in the identification information of the designated recording medium by comparing an identification information corresponding to the designated recording medium in the registration file with the corresponding identification information stored in the storage device; and
a controller which displays on the display a message indicating failure in access to the recording medium, when the detector detects change in the identification information.

2. A digital image signal processing apparatus according to claim 1, wherein
the acquiring device acquires the registration file from a specific recording medium among the recording media, when the registration file is stored in the specific recording medium among the recording media.

3. A digital image signal processing apparatus according to claim 1, further comprising:
a result storing device to store detail information in association with detection results obtained by the detector,
wherein the controller displays on the display a message indicating failure in access to the designated recording medium, and reads a corresponding detail information and display the detail information on the display.

4. A digital image signal processing apparatus according to claim 3, wherein:
the acquiring device acquires a registration file describing the identification information and initialization count information of the recording media corresponding to the respective identification information;
the storing device stores the initialization count information of the recording media in association with the identification information;
the result storing device stores a detail information used in the case where the corresponding initialization count information match, and a detail information used in the case where the corresponding initialization count information do not match; and
the controller reads the corresponding detail information from the result storing device based on the detection result obtained by the detector, and displays the corresponding detail information on the display.

5. A controlling method used in a digital image signal processing apparatus selectively performing reading and writing of any digital image signal to a designated recording medium among a plurality of recording media, to each of which a digital image signal is writable, and displaying the digital image signal which is being at least one of read and written on a display, the method comprising:
storing a plurality of identification information for identifying the respective information media on a nonvolatile memory;
acquiring a registration file describing identification information items of the respective recording media in initial registration, if there occurs a request to execute writing or reading of a digital image signal, the request designating one of the recording media;
comparing an identification information corresponding to the designated recording medium in the registration file with the corresponding identification information stored in the nonvolatile memory, and thereby detecting change in the identification information of the designated recording medium; and
displaying on the display a message indicating failure in access to the recording medium, when the change in the identification information of the designated recording medium is detected.
